(19) United States
(12) Patent Application Publication
(10) Pub. No.: US 2016/0344777 A1
(43) Pub. Date: Nov. 24, 2016

(54) SYSTEM AND METHOD FOR PROVIDING A MEDIA COMMUNICATION CONVERSATION SERVICE

(71) Applicant: Twilio, Inc., San Francisco, CA (US)

(72) Inventors: Christer Fahlgren, San Francisco, CA (US); Ameya Lokare, San Francisco, CA (US); Torkel Dominique, San Francisco, CA (US); Nicolas Acosta, San Francisco, CA (US)

(21) Appl. No.: 15/157,809

(22) Filed: May 18, 2016

Related U.S. Application Data
(60) Provisional application No. 62/163,233, filed on May 18, 2015.
(60) Provisional application No. 62/243,785, filed on Oct. 20, 2015.

(51) Int. Cl. H04L 29/06; H04M 7/00

(52) U.S. Cl. CPC H04L 65/1066; H04L 65/1059; H04M 7/0021; H04L 65/1093; H04L 65/4023

(57) ABSTRACT

A system and method comprising configuring a conversation resource for an account within a communication platform; registering a set of endpoints as participants of the conversation resource; establishing a synchronous media communication session of the conversation resource according to at least the set of endpoints; maintaining the state of the conversation resource in synchronization with events of the synchronous media communication session; and servicing at least one programmatic interface to the conversation resource.

### CROSS-REFERENCE TO RELATED APPLICATIONS

This Application claims the benefit of U.S. Provisional Application No. 62/163,233, filed on 18 May 2015, and U.S. Patent Application No. 62/243,785, filed on 20 Oct. 2015, both of which are incorporated in their entireties by this reference.

### TECHNICAL FIELD

This invention relates generally to the communication field, and more specifically to a new and useful system and method for providing a media communication service in the communication field.

### BACKGROUND

Currently, people have various ways to communicate in real time. Audio calls over the phone are still a main form of communication for many people. In recent years, audio calls over the internet have become common, as well as video calling. However, many of these forms of communication are siloed within a technology ecosystem that prevents the communication process from being customized for different use-cases. A developer that wants to build a real-time communication experience is faced with using inflexible communication technology or building a large amount of technology to support basic features. Both options are often unattractive to a developer, especially if the real-time communication would be built into an application as a feature as opposed to the main product. Thus, there is a need in the communication field to create a new and useful system and method for providing a media communication conversation service. This invention provides such a new and useful system and method.

### BRIEF DESCRIPTION OF THE FIGURES

FIG. 1 is a schematic representation of a system of a preferred embodiment;

FIG. 2 is a flowchart representation of a method of a preferred embodiment;

FIG. 3 is a schematic representation of a variation of the method utilizing account configuration in determining mode of communications across different accounts;

FIG. 4 is a schematic representation of a variation of the method utilizing conversation configuration in determining mode of communications across different conversations;

FIGS. 5 and 6 are schematic representations of a conversation resource utilizing an anonymization option;

FIG. 7 is a communication flow diagram representing a variation of augmenting a communication according to changes in a conversation resource;

FIG. 8 is a communication flow diagram of automatic routing enabled by a conversation resource;

FIG. 9 is a communication flow diagram of expiring an automatic routing conversation resource; and

FIGS. 10 and 11 are communication flow diagrams of the conference resource applied to a conference use case.

### DESCRIPTION OF THE PREFERRED EMBODIMENTS

The following description of preferred embodiments of the invention is not intended to limit the invention to these preferred embodiments, but rather to enable any person skilled in the art to make and use this invention.

### 1. System for Providing a Media Communication Conversation Service

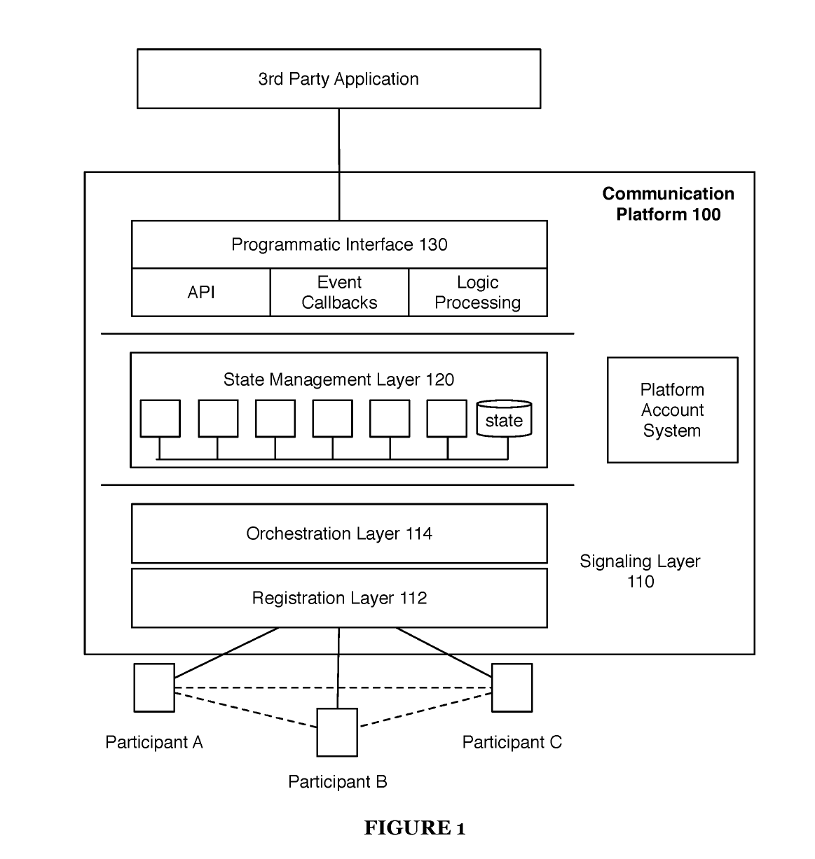

As shown in FIG. 1, a system for providing a media communication conversation service of a preferred embodiment can include a communication platform 100 that includes a signaling computing layer 110, a state management layer 120, and a programmable interface layer 130. The system functions to provide a multi-tenant service that provides a set of communication primitives that can be applied to setting up and managing communications. The system may be applied to synchronous communications such as audio or voice calls or to asynchronous communication such as text or media messaging. The system functions to coordinate between various client devices, remote services, internal or external application modules, and/or other computational entities. The system can function in part to orchestrate endpoints, sessions, and media services by managing the real-time state of multi-party conversations.

The system is preferably implemented to be multi-modal in nature, supporting various media mediums such as audio, video, screensharing, virtual environments, one-to-many video or audio broadcasting, and/or other suitable forms of data streams. Correspondingly, the system can support multiple types of endpoints including PSTN devices, SIP devices, browser clients (e.g., using some communication library), native application clients (e.g., using an SDK or implementing various APIs), 3^{rd} party communication channel endpoints, and/or any suitable type of endpoint.

The system can additionally address multi-party communications, supporting one-to-one communications as well as group communications greater than one. In one variation, the system can additionally support communications with a single endpoint, wherein that endpoint is connected to a virtual endpoint such as some automated communication application. The number of participating endpoints and the nature of their participation (e.g., active participants or passive listening participants) can vary between the set of conversations serviced by the system.

Furthermore, the system can make conversations programmable, such that customized logic and data insights can be applied and/or extracted from communications. The programmable aspects may involve API access to representational resources of a conversation, participants, event callbacks (e.g., webhooks that call out in response to various events), application logic, and/or other suitable forms of programmable interfaces. Accounts can integrate various applications and services with the communication platform 100 and utilize programmable interfaces such as conversation API resources and participant API resources as an abstracted approach to building a communication application.

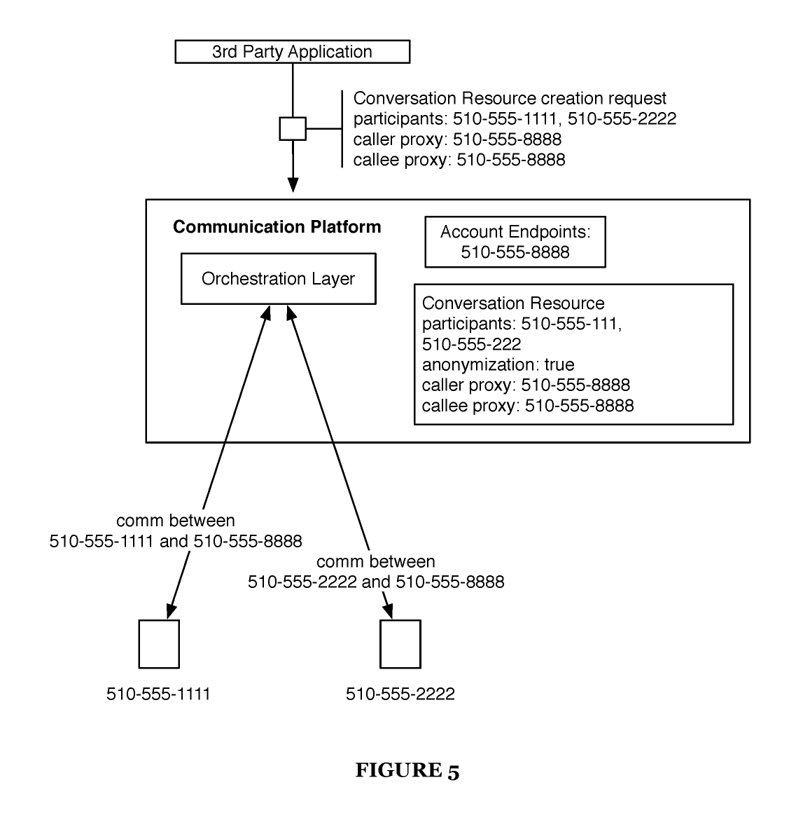

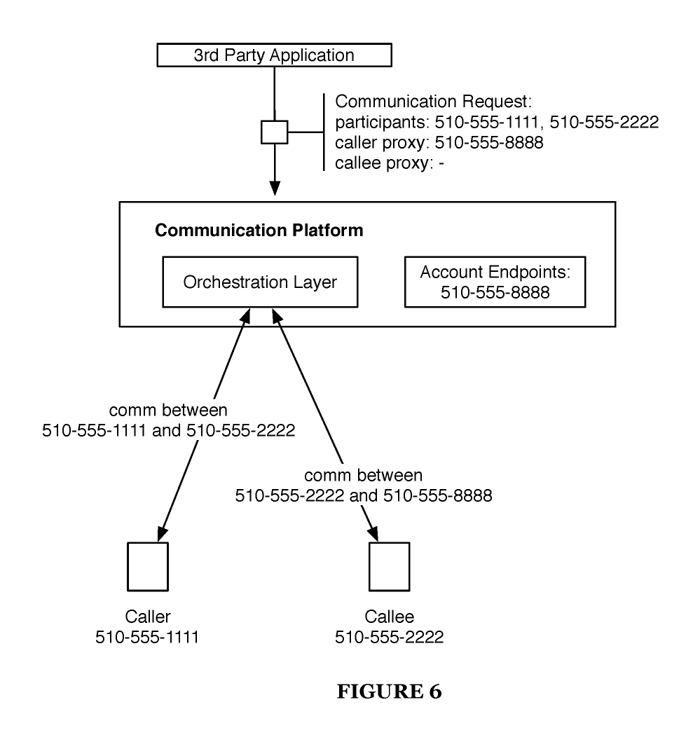

In some variations, the API resources and other programmatic interfaces can address common usage scenarios. For example, anonymous communication where one or more parties use a proxy endpoint when communicating with another endpoint can be automatically enabled through an API resource. Such a scenario may be beneficial when worker to client communication is being facilitated by a business such as when a taxi company wants to connect a driver to a customer without revealing the personal phone numbers of the driver and customer to each other. When setting up a communication using a conversation resource, an option can be selected so that a proxy endpoint (e.g., an endpoint of the managing account) is used for any leg where there is a desire to anonymize one or more participants as shown in FIGS. 5 and 6.

The communication platform 100 functions to provide communication services to developer applications and services. The system is preferably implemented in combination with a communication platform 100 such as the one described in patent application Ser. No. 12/417,630 filed 2 Apr. 2009, entitled “System and Method for Processing Telephony Sessions”, which is hereby incorporated in its entirety by this reference. The communication platform 100 preferably enables application execution in connection to communication sessions and/or messages; the communication platform 100 may additionally or alternatively provide an application programming interface (API) as an alternative for interacting with communication functionality of the communication platform 100. The communication platform 100 can be designed for one or more mediums of communication. The communication platform 100 may support various forms of communication in addition to the mediums described herein. For example, asynchronous messaging such as SMS, MMS and IP messaging capabilities can be supported in addition to synchronous communications.

The communication platform 100 is preferably a multitenant communication platform 100 that allows multiple accounts to use the communication platform 100 in facilitating communication tasks. An account generally refers to a mechanism for scoping data, usage, and billing of entities utilizing the multitenant communication platform 100. Additionally, each account within the multitenant communication platform may itself have a subaccount. Accordingly, an account may support multiple communications for different sub-account holders wherein communication, data/analytics, billing, and/or other aspects can be scoped to an account, a sub-account, or any suitable scope. Herein, account will be used to refer to any suitable type of account including parent accounts, sub-accounts, or other alternative types of entities. The communication platform 100 can additionally be a cloud-hosted platform. The communication platform 100 can be a server, a server cluster, a collection of components on a distributed computing system, or any suitable network accessible computing infrastructure. The communication platform 100 can be implemented in part through a service-directed architecture wherein different operational responsibilities of the platform can be subdivided between different internal services. Those services can be composed of multiple servers or machine nodes, which can preferably be scaled out horizontally and workload balanced across the set of nodes.

The signaling computing layer 110 functions to coordinate media and signaling with various endpoints. The signaling computing layer 110 can be the layer through which client devices connect to the communication platform 100 when participating in a communication conversation. The signaling computing layer 110 can include a registration layer 112 and an orchestration layer 114.

The registration layer 112 functions to manage registration of endpoints so that they can participate in a conversation. Registration includes establishing the network location of the endpoint so that communications can be routed to the endpoint. An endpoint when wanting to participant in a communication or become available to receive communication requests will register with the communication platform 100 through the registration layer 112. The registration layer 112 can additionally handle registration updates if the network location of an endpoint changes. The registration layer 112 may additionally manage multiple device registrations of a single addressing endpoint. In this variation, an endpoint can have multiple endpoint instances. An endpoint instance can be various client devices or applications that are registered/authenticated to act as the endpoint. Endpoints and their associated endpoint instances can be characterized as participant resources within the communication platform 100. The programmable interface layer 130 can expose participant resources as an external API.

In one variation, the endpoint addressing scheme is scoped per account, such that the endpoint addressing is unique within the account. The registration layer 112 may use a global namespace wherein an endpoint address is unique throughout the platform. An internal addressing scheme may be used but an externally managed addressing scheme may alternatively be used. Since the system may support multiple types of endpoints, there may be multiple types of endpoint addresses. In one variation, the endpoint addressing is particularly assigned to a particular device, sub-account, participant, or entity. Additionally or alternatively the endpoint addressing may support anonymous entities and ephemeral entities wherein an addressing scheme is used to temporarily associate with a particular endpoint.

The orchestration layer 114 functions to coordinate and negotiate media connections with endpoints participating in a conversation. The orchestration can cooperatively coordinate with the registration layer 112 to establish real-time media streams between involved endpoints of participants in a conversation. In an alternative variation, the registration layer 112 and the orchestration layer 114 could be implemented as a combined resource fulfilling both operations. As independent services, each layer can be scaled independently. The orchestration layer 114 can establish media paths peer-to-peer (P2P) or through a hosted media service(s). Intermediary media services may provide various forms of media communication capabilities. Media services can include a TURN service, an audio mixing service, a video mixing service, a transcription service, a recording service, a transcoding service, and/or any suitable type of media service. For example, media may be routed through a TURN media server when P2P services cannot be established. In another example, an audio mixing media service may provide larger number of participants and additional capabilities such as DTMF detection, recording, speaker detection, channel muting, and/or other suitable features. In yet another example, a video routing service can be integrated in the media stream with one or more endpoints. The video routing service may provide interoperability between audio and video endpoints. In one variation, interoperability may extend video conferencing to endpoints connecting over PSTN.

The orchestration layer 114 can address establishing the media communication, but can additionally be maintained as an intermediary node in the signaling path between the participants. Various events and updates during the communication can be synchronized with the system through the orchestration layer 114. Additionally, media paths can be renegotiated in response to different changes such as participant changes, participant role changes, media quality issues, and/or other suitable events.

The state management layer 120 functions to maintain and synchronize state of conversations. Events and the state of a conversation are tracked and can be synchronized with a conversation resource. A conversation may involve one or more communication sessions or messages. The state of a conversation and the participants is preferably monitored and managed within the state management layer 120. The state management layer 120 can provide higher-level information built on top of the signaling layer. The signaling layer can coordinate with the state management layer 120 to communicate changes within a conversation. The signaling layer can additionally apply conversation state changes as directed from the state management layer 120. The state management layer 120 is preferably a persistent data layer wherein conversation state is synchronized across the state management layer 120 such that any node can access and act on updated conversation state information. In one preferred implementation, the state management layer 120 includes an in-memory data grid through which data is persisted across the layer. Data persistence can make the state management layer 120 persistent to node failure. If a node encounters an error and is deallocated, the state of a conversation can be maintained and recovered preferably with no interruption to the communication session.

The conversation state can include information such as status information, start time, end time (if ended), duration of the communication, media format, the number of participants, individual participant information, programmatic interface configuration, and/or any suitable information. The status information may include the states of “created”, “in-progress”, “ended”, and “failed”. Other suitable states may additionally or alternatively be used. The participant information may include endpoint address, participant status (e.g., created, invited, connected, disconnected, failed, etc.), conversation start/end time, speaking duration (e.g., contextual information on ho much the participant has said), communication media (e.g., how they are communicating in the conversation), and/or other participant information. In the case, where multiple communications are associated with the conversation, information for each communication session and/or message can be associated with the conversation state. For example, when a conversation resource is used to map asynchronous messages between two participants, each message can be logged as part of the history of the conversation.

The programmable interface layer 130 functions to enable the context of a conversation to be built into custom business logic and other outside applications. The programmable interface layer 130 can provide one or a number of programmatic interfaces such as an API, an event callback system, or application logic processing system.

An API service is preferably a RESTful API but may alternatively be any suitable API such as SOAP or custom protocol. The RESTful API works according to an application layer request and response model. An application layer request and response model may use an HTTP-based protocol (HTTP or HTTPS), SPDY, or any suitable application layer protocol. Herein, HTTP may be used, but should not be interpreted as being limited to the HTTP protocol. HTTP requests (or any suitable request communication) to the communication platform 100 preferably observe the principles of a RESTful design. RESTful is understood in this document to describe a Representational State Transfer architecture as is known in the art. The RESTful HTTP requests are preferably stateless, thus each message communicated contains all necessary information for processing the request and generating a response. The API service can include various resources, which act as API endpoints that can act as a mechanism for specifying requested information or requesting particular actions. The resources can be expressed as URI's or resource paths. The RESTful API resources can additionally be responsive to different types of HTTP methods such as GET, Put, POST and/or DELETE. Information about a conversation is preferably stored and made accessible through conversation API resources. Additionally participant API resources can be created and made accessible. In addition to obtaining information, actions can be initiated through the API. For example, conversations may be initiated or ended, participants can be added or removed, media features enabled or disabled, and/or any suitable action can be triggered.

There may be a variety of approaches to implementing an API for interacting with conversation resources. In one preferred implementation, the API service includes a conversation resource. The conversation resource can include a participant's property and a communication mode property. The participant's property is preferably a set of participants. The API service can include a participant resource, wherein properties of a participant can be set. Alternatively, properties of a participant may be directly specified within a participant property of the conversation resource. In one implementation, the participant's property functions to create an automatic routing mapping for any incoming communication from one of the participants. As one potential benefit interactions between participants are automatically grouped and accessible within the conversation resource. As another potential benefit, the set list of participants can enable automatic routing of incoming communications, which can be used for anonymizing communications, automatically translating the type of communication to accommodate different participants, and other uses. The list of participants may be specified before a communication. In one variation, a conversation resource is automatically created for a communication between participants for which a conversation resource doesn't apply. The participants may additionally be changed after the creation of the conversation resource such that participants could be added or removed from a conversation.

The communication mode property can specify the types of communications supported. In some variations this may define different capabilities. The communication mode property may be set based on the type of account, customized for each conversation, and/or customized based on the set of participants.

A conversation resource may additionally include an expiration property, which can be a time or event based condition determining when the conversation is active. An expiration time may be used to automatically expire conversation sessions after a particular time period. For an account using the system to facilitate on-demand services provided by a worker from some client, the client and worker may need to communicate for the time of the work. The account may set a time window of one hour so that the communications from the worker or client are stopped from automatic routing after a typical job is done.

The resources of the API service are preferably scoped by account, subaccount or other suitable entity. Each conversation resource or participant resource is preferably associated with an account. In some alternative implementations, conversations may be enabled across accounts, have a global scope, or be otherwise scoped.

An event callback system can function to enable event triggers or webhooks to be activated in response to different state changes or events. Event callbacks can be account-customized conditions that result in an event response when the condition is satisfied. An event callback configuration can leverage internal information of the platform but without exposing the used internal information to an outside account entity. When an event callback condition is satisfied, a configured event is executed. The event could be an internal operation, a callback event, or any suitable action. An internal operation can be a closed action that may not be fully exposed to an account holder. A URI callback event preferably includes making an application layer protocol communication to an external resource located at the specified URI. A callback event may alternatively be configured by account for any suitable event such as when a conversation starts, when a conversation ends, when a property of a conversation satisfies some condition or threshold, or any suitable condition.

Application logic processing may enable business logic to be defined through an executable document. Preferably, application logic is specified through a structured document. In one variation, a markup language document can be used in specifying a set of instructions and conditions that can be sequentially executed. The application logic may be retrieved from a remote server. For example, the event callback system may retrieve application logic from a URI, which is then processed in association with a conversation. Application logic may alternatively be stored within the communication platform 100.

### 2. Method for Providing a Media Communication Conversation Service

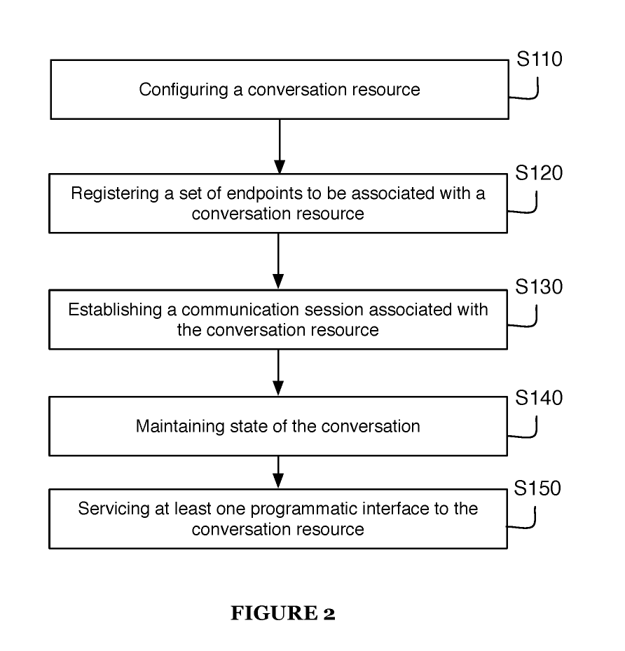

As shown in FIG. 2, a method for providing a media communication conversation service can include registering a set of endpoints to be associated with a conversation resource S120, establishing a communication session associated with the conversation resource S130, maintaining state of the conversation S140, and servicing at least one programmatic interface to the conversation resource S150. The method functions to provide a platform service that can facilitate various media session use-cases. The method can be used to service call centers, social application like dating apps, conference call services, video broadcasting, and/or any suitable communication conversations.

The method is preferably implemented by a system substantially similar to the one described above. The various processes of providing a conversation service can be implemented within a multitenant platform wherein the method processes may be facilitated through distinct architecture layers that can be independently scaled. A registration layer may facilitate registering of endpoints; an orchestration layer can facilitate establishing a communication session of a conversation; a state management layer can facilitate maintaining state of a conversation; and a programmatic interface layer can facilitate servicing a programmatic interface. The method may alternatively be implemented by any suitable system. Similar to the system described above, the method may be used for synchronous media communication sessions and/or for asynchronous messaging communications.

When implemented within a multi-tenant platform, the method can enable multiple accounts to more easily implement communication technology within a third party service or application. The method may additionally include configuring a conversation resource S110 with media-enabled capabilities. The method can accommodate customization per account based on the various requirements and objectives of each account. Furthermore, the facilitation of a conversation through a programmatic conversation resource can abstract away many complexities of the underlying media management. Two different accounts may both use a conversation resource mechanism while one account uses a peer-to-peer media transport architecture while a second account has media mixed and routed through the communication platform. Additionally, an account could easily adjust the media management without significant changes to how the conversation resource is used. For example, an account may initially sign up for peer-to-peer media transport initially, and then upgrade to media mixing through the platform when the requirements of the application changes without altering client code.

Block S110, which includes configuring a conversation resource, functions initialize communications associated with the conversation resource to have a particular type of behavior. Configuring a conversation resource may impact communication mode of associated communications and/or participant routing. Other properties may additionally be configured such as media capabilities, communication anonymizing, and/or other properties.

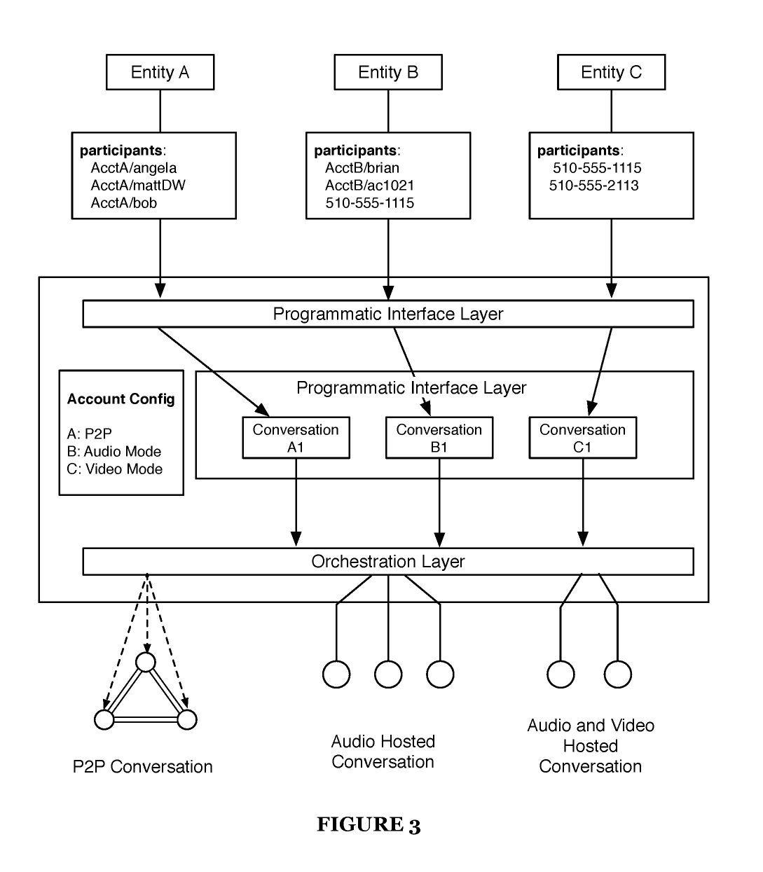

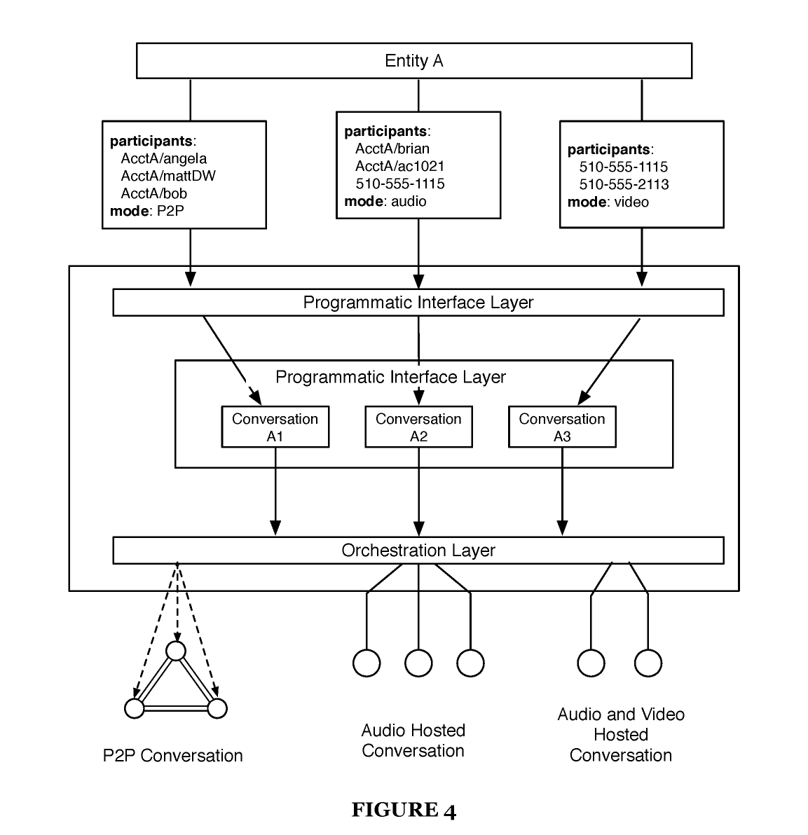

Configuring a conversation resource for a mode of communication functions to direct media negotiation based on configuration within the communication platform. In one variation, configuring a conversation resource with media-enabled capabilities includes configuring an account for a set of enabled media capabilities and applying the enabled media capabilities to conversation resources of the account as shown in FIG. 3. In one instance, an account can be set up in one of a set of conversation modes. In one preferred implementation, enabled media capabilities of an account are determined by setting an account to a communication mode selected from the set including a peer-to-peer media mode and a media hosted mode. The peer-to-peer media mode establishes media streaming channels between the involved participants, preferably without streaming media through the communication platform. The media hosted mode utilizes streaming media through the platform, which may be easier for network traversal, mixing, or providing media-based services like recording or transcription. The media hosted mode may include various customized media hosting capabilities. There can be an audio version of a media hosted mode and a video hosted mode. In another variation, the set can include a peer-to-peer media mode, an audio mixing media mode, and a video and audio mixing media mode. Alternatively, the communication mode may be specified when creating a conversation as shown in FIG. 4.

Configuring a conversation resource for participant routing can function to pre-specify how a communication is to be routed. Participants can be set and then when incoming communications are received from one of those participants and associated with the account, the communication can be automatically routed to the participants specified in the conversation resource. In one scenario, an account may enable a conference call by creating a conversation resource with all the participants to be included in the call. The participants may be automatically connected to a conference when they call from a registered endpoint. Alternatively, when a participant calls an endpoint of the account the system can automatically dial out to the other participants. In another scenario, the conversation resource can setup automatic anonymization. A proxy endpoint can be configured through an anonymizing property of the conversation resource. A proxy endpoint may be specified. The proxy endpoint is preferably either an endpoint managed by the account as shown in FIGS. 5 and 6. The proxy endpoint may alternatively be an endpoint of the platform, a subaccount, one of the participants, or any suitable entity. Anonymizing may be applied across all participants. Alternatively, different legs of a communication can be selectively anonymized as shown in FIG. 6. When one of the participants establishes a communication with the proxy endpoint, a second leg of communication is established and bridged between the proxy endpoint and the other configured participant(s). The automatic routing to participants can additionally operate across communication modes. By configuring one conversation resource, a PSTN phone call may be bridged to an IP voice endpoint; a SMS message can be automatically routed to other participants; and a video call could be established with participants with video capable endpoints.

Block S120, which includes registering a set of endpoints to be associated with a conversation resource, functions to establish communication endpoint availability and access within the platform. The endpoints are preferably registered as participants of a conversation resource as described above. The registering of endpoints is preferably a primary approach to establishing a synchronous communication session for an application or service utilizing the communication platform. Account holders may be alleviated of directly managing or implementing underlying media handling. The conversation platform is preferably multitenant. Accordingly, multiple accounts and distinct entities share use of the platform. The registration of endpoints is preferably scoped to an account namespace or a sub-account namespace. Alternatively the namespace may be global across all accounts or a subset of accounts or defined with any suitable scope. The communication platform may support a variety of endpoint types such as browser endpoints, application endpoints, PSTN endpoints, third party service endpoints, or any suitable type of endpoints. A browser endpoint may use a provided library in interacting with the communication platform. A native application endpoint may use a provided SDK in interacting with the communication platform.

Registering a set of endpoints preferably comprises receiving a set of registration requests. The registration requests preferably indicate the associated endpoint and the capabilities of that particular client instance of the endpoint. An endpoint can be an addressable identifier for connecting with a party. An endpoint instance is preferably a client identifier (e.g., 3^{rd} party communication service and username) or address (e.g., a phone number or IP address) that is used for routing communication specifically to a communication device.

The registration is preferably executed through the registration layer of the communication platform. In registering a single endpoint, a registration request is received at the communication platform and more specifically the registration layer. A request may be load balanced across the set of registration service instances. The registration request can include endpoint information such as account information, endpoint instance identifier, endpoint type, endpoint capabilities, and endpoint status. Depending on how an endpoint is registered, the availability of the endpoint may depend on the type of communication. Additionally, multiple instances of an endpoint may be registered for a single endpoint address and/or participant. For example, multiple application instances may each be registered as an endpoint instance of a participant resource. The participant may be accessible by referencing any of the endpoint instances. For example, the participant could be addressed by referencing a phone number, a SIP endpoint identifier, or a social network communication username if an endpoint instance for each of those communication modes is registered for the participant. Alternatively, one or more of the endpoint instances may be used as an exposed endpoint, which can be used to address the participant. In another example, a user may register with their phone and register using the same username with a desktop computer. In the case where the endpoint address is a phone number, the endpoint instances can be client identifier but may additionally include a client identifier that is the phone number. For example, an application may be an endpoint instance and a phone number may be a second endpoint instance. The registration layer can manage prioritization and distribution of communications between multiple endpoint instances. Registering a set of endpoints can similarly include deregistering of an endpoint. An endpoint may be deregistered in response to a request, an API request, a timeout, or any suitable condition.

In some variations, registering an endpoint can include setting up authentication of the endpoint. This can be the case when establishing a 3^{rd} party communication channel (e.g., an “over the top” communication channel) such as a social network messaging platform. The authentication process may be customized according to the particular 3^{rd} party communication channel.

In one implementation, participants may be established without being associated with a conversation resource or with one or more conversation resources. This may enable participant preferences to be established and persisted as they participate in different conversations. This may enable authentication with a 3^{rd} party communication channel to be completed so that communication can be established with that communication mode for that participant.

In one variation, a registration request can be part of a request to create a conversation resource. For example, a device wanting to setup a conversation with a set of other participants will send a request to create the conversation resource and attempt to activate the listed participants. If an endpoint instance of a participant is already registered and active that participant may be connected. Alternatively, an invite or notification may alternatively be sent to a participant that is offline.

Additionally or alternatively, a set of registration requests may each specify a conversation identifier wherein each endpoint instance self registers by self-identifying the conversation identifier. Policy may be enforced to restrict the participants. Restricting a participant can involve restricting the total number of participants, restricting the type of client devices used by an endpoint, restricting the type of interactions during a communication, and/or any suitable limit.

When an endpoint is registered, a participant resource can be created or alternatively updated to reflect the status of the endpoint. Information about an endpoint that is currently or had previously registered may be made accessible through a programmatic interface. For example, an API can be used to access an endpoint's registration status. In another variation, a callback event may be triggered during registration or deregistration of an endpoint.

Block S130, which includes establishing a communication session associated with the conversation resource, functions to setup media for an active session of communication between a set of registered endpoints. The communication session can be a synchronous media session that includes at least one way media stream. The media can be audio, video, data, or any suitable type of media stream. The communication session could be for a two-party call, a conference call, a one-to-many broadcast session, a real-time application collaboration session, and/or any suitable application. The communication session may alternatively be transmission of an asynchronous message between registered endpoints. Transmitting an asynchronous message can include sending an SMS text message, sending an MMS message, sending a text or media IP message, and/or sending a 3^{rd} party communication channel message.

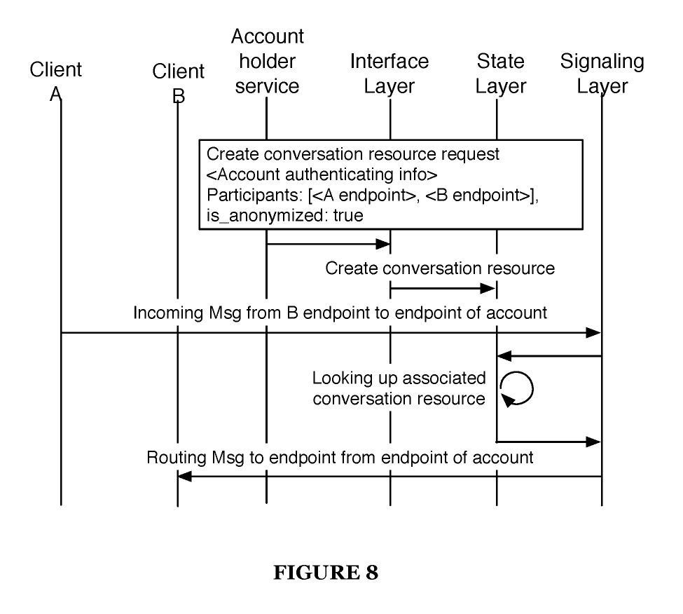

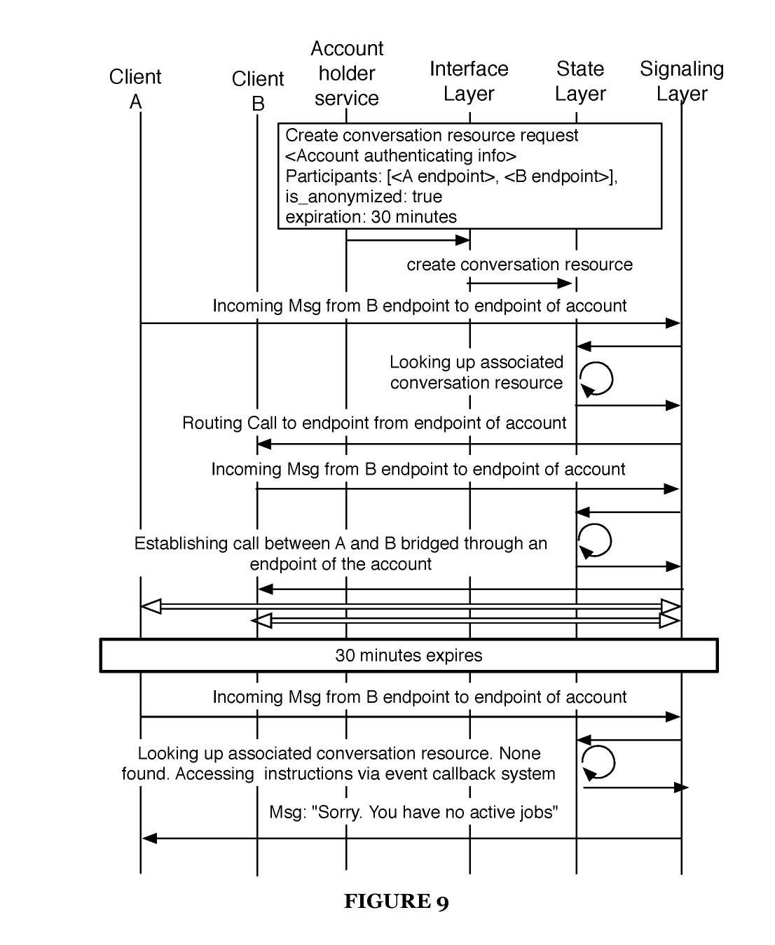

Establishing a communication session is preferably in response to some request. The communication session can be established once some participant condition is satisfied. A participant condition could be when an inbound communication is received by a participant. A received communication may be mapped to a conversation resource to determine how a communication session should be established. In one instance, the origin endpoint of the communication and one of the destination endpoints of the communication is used to identify the corresponding conversation resource. The inbound communication can then be routed to the other participants of the conversation resource. If the inbound communication is a call, the call may be bridged to one or more participants. If the inbound communication is a message, the message may be forwarded to one or more participants as shown in FIG. 8. The conversation resource can act a simple approach to design automatic routing, while avoiding implementing custom logic. In one variation, the conversation resource may be set to expire so that the mapping isn't persisted forever. As shown in FIG. 9, multiple communications (possibly over different mediums) can be automatically routed between participants until the conversation resource expires. A default behavior may be configured for cases where a conversation resource cannot be mapped to an inbound call. Preferably, an error message response is played or the communication is redirected. In another variation, the conversation resource can be set to automatic anonymizing proxy option, wherein the communication is routed and proxied with a proxy endpoint. The automatic anonymizing proxy option functions to hide endpoint details from one or more participant, which may be beneficial to preserve privacy in certain applications.

A participant condition could be when all participants of a conversation resource have successfully dialed in and are ready to join or when some minimal number of participants are ready to join. Establishing the communication session can involve determining the endpoint instance of a participant to use and negotiating media streams between the set of endpoints. Determining the endpoint instance may be a direct mapping if only one endpoint instance is registered (or permitted). However, in some implementations, an endpoint instance may be selected based on participant preference, endpoint instance capabilities, and/or other factors. For example, if a user has two different endpoint instances registered and active but only the first endpoint instance supports video, then the first endpoint instance is selected when the conversation is to include video media.

In one variation, a STUN and/or STUN/TURN service can be used in negotiating network traversal. A STUN service establishes negotiates peer-to-peer (P2P) media flow. When the P2P media flow is established, the communication platform preferably is removed exit from the media path. The STUN/TURN service can attempt to establish P2P media flow, but default to a media relay through the communication platform if P2P media cannot be established.

Establishing the communication session may additionally include routing media through the communication platform. As opposed to negotiating P2P media flow, media is negotiated between the participants to use the communication platform as an intermediary. Participants may be invited to establish a media stream with the communication platform and a computing resource of he communication resource bridges the media streams together to establish the communication session. Depending on the type of endpoints, the session conditions, and/or feature requirements, the media stream of the communication session may be established through a particular media service. The communication platform can provide media mixing, media transformations, media analytics, and/or other media services when acting as an intermediary note in the media stream between participants. For example, an audio media service or a video media service may be used, wherein the audio and video services include particular audio or video service capabilities.

The method can additionally include establishing the communication dynamically according to the mode of the conversation resource, which functions to intelligently select the media streaming approach for a particular conversation. The set of modes can include a P2P mode and a media hosted mode. The set of modes may include additional or alternative modes as well. In another variation, the modes can include a P2P mode, an audio hosted mode, and an audio/video hosted mode. In one variation, a conversation resource can be individually configured. When creating the conversation, and application or service can indicate the mode that the conversation should operate. Alternatively, the mode can be determined based on the characteristics of the conversation. For example, a conversation resource may indicate the media format, the number of participants, and/or other features. The mode may additionally or alternatively utilize the capabilities of the participants, the geographic locations, and/or other characteristics to determine the mode.

In one implementation, the mode of a conversation resource is determined by the managing account. The type of account may determine what modes are available. For example, a free account may only be permitted a P2P mode, and pro account may be permitted audio or a video and audio mode. Similarly, an account manager may directly control the default mode for conversations. A setting within an account portal may be set and updated by an account manager.

Block S140, which includes maintaining state of the conversation resource, functions to make the conversation status accessible to the communication platform. Various updates made through a conversation service can be synchronized with a stateful representation of the conversation. Changes to state of a conversation and/or participants is preferably synchronized with the corresponding conversation resource and/or participant resources. Maintaining state of the conversation can include tracking the conversation across at least the set of states including “created”, “in-progress”, “ended”, and “failed”. Additional information such as duration, creation date, start time, end time, and/or other state information may be tracked. Additionally, participants and/or other aspects relating to the conversation can have maintained state. Participant state information may include status information, which can include the states of “created”, “invited”, “connected”, “disconnected”, and/or “failed”. Participant state information can additionally include date created, start time, end time, duration of participation, and/or other suitable properties. Another piece of state information may include a Boolean representing whether the participant is currently talking or not. Another piece of state information may include emotional state such as classifiers including “angry” and “content”.

To facilitate scalability and robustness of the communication platform, maintaining state of the conversation can include persisting state data across nodes of the state management layer. State information can be persisted across different nodes so that state information is kept consistent and available.

Block S150, which includes servicing at least one programmatic interface to the conversation resource, functions to allow programmatic control and information access for a conversation. The programmatic interface to the conversation can be made through a programmatic interface layer. The programmatic interface could be an API, an event callback system, or application logic processing.

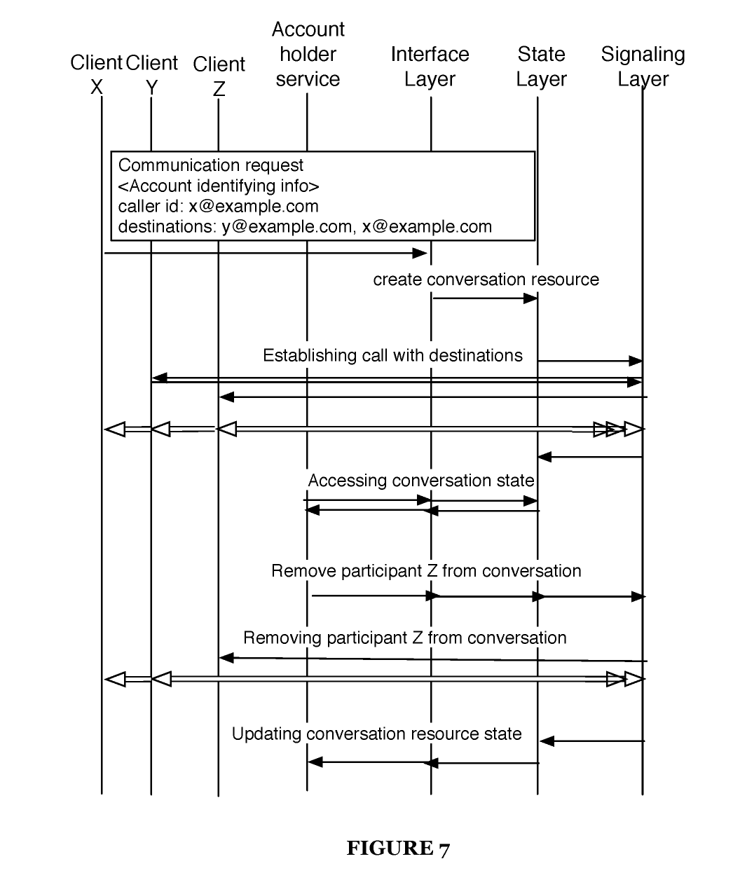

Servicing a programmatic interface can include exposing state of the conversation resource through an API. An API can enable asynchronous requests to be made. An API can be used for accessing historical information for one or more conversations. For example, an account could use the API to retrieve all conversations made in the last 24 hours. The API may alternatively be used to access specific information for a particular conversation. In yet another variation, the API may be used to access information of active conversations. The API may additionally be used to augment or make changes to a conversation resource, a participant resource, or other API resource. For example, a conversation may be started or ended. Similarly, a participant may be added or deleted as shown in FIG. 7. The API is preferably an application layer API such as a REST API, and more specifically the API is preferably an HTTP-based API. As described above, the state of the conversation resource can include a classification of the conversation as: created, in-progress, ended, and failed.

In servicing an event callback system, an event is triggered when a particular condition of a conversation is satisfied. The event could be an internal action executed by the communication platform such as immediately ending a call. The event may alternatively include making an application layer protocol request to a specified URI. The application layer protocol request can be made with conversation state information. Preferably a callback URI can be registered for an event, and when that event occurs an HTTP request is made to the configured callback URI with the state information. For example, an event could be triggered for when there is a change in the talking state of one of the participants. A service could use such a feature to indicate what participant is talking at any given time. Servicing an application logic processing interface can enable application logic to be executed in association with a conversation. The application logic could be a script, a program, an application, or any suitable set of executable instructions. The application logic may alter state of a conversation, act as a virtual participant, or perform any suitable task. Various programmatic mechanisms can be made available to logic process. In one implementation, the events used in the event callback interface can be made as called events in the application logic.

The system and method may be applied to address a variety of use cases. The system and method can provide an abstracted approach to establishing various communication setups. The system and method may be used for enabling simplified management of how media is managed. The system and method may be used for anonymizing and expiration of synchronous and asynchronous communications. The system and method may be used for simplified conferencing.

Simplified management of underlying media management functions to create a consistent developer interface when establishing communication. This can be particularly useful when dealing with video or other high bandwidth media stream. Simplified media management can additionally be useful when there are a wide variety of communication channels including 3^{rd} party communication channels. The method for automatically managing media can include configuring media management within some scope. The mode of media management is preferably set within an account. Any communications and conversations associated with this account inherit the media management. For example, an account could be setup for P2P or media hosted management. The mode of media management may alternatively be set within a conversation resource. A communication executed associated with that conversation resource would utilize the communication mode of that conversation resource. For example, a conversation resource setup for P2P will negotiate P2P media sessions for all communications associated with that conversation. The mode of communication may alternatively be specified within a particular communication request. The mode of media management can additionally be changed. At an initial point in time, an account may be configured so that video communications utilize peer-to-peer communications, but as demands change, the account can change account configuration at a second point in time so that subsequent communications are made through a media hosted approach.

Anonymizing and expiring communications functions to enable ephemeral communications to be easily setup for participants that have a temporary need to communicate. A service provider that wants to facilitate connecting two or more individuals for a limited time may benefit from such an offering. The method for anonymizing preferably comprises configuring a conversation resource. The conversation resource is configured with the participants. This will enable automatic routing between the participants. If an anonymizing proxy option is enabled in the conversation resource then the endpoint of a participant may be anonymized with a proxy endpoint. The endpoint proxy can be an endpoint of the platform, the account, or any suitable proxy. The anonymizing proxy mode can use a hosted media communication mode. All legs of a communication may be proxied as shown in FIG. 8, but only select endpoints may be proxied. If an expiration option is enabled, then the conversation resource may become inactive after expiring. An active conversation resource can be used in establishing communications. An inactive conversation resource cannot be used in establishing communications. The conversation resource is preferably persisted within the platform for future access by the account. A conversation resource can be expired based on a time limit as shown in FIG. 9 but may alternatively be based on number of communications or any suitable condition.

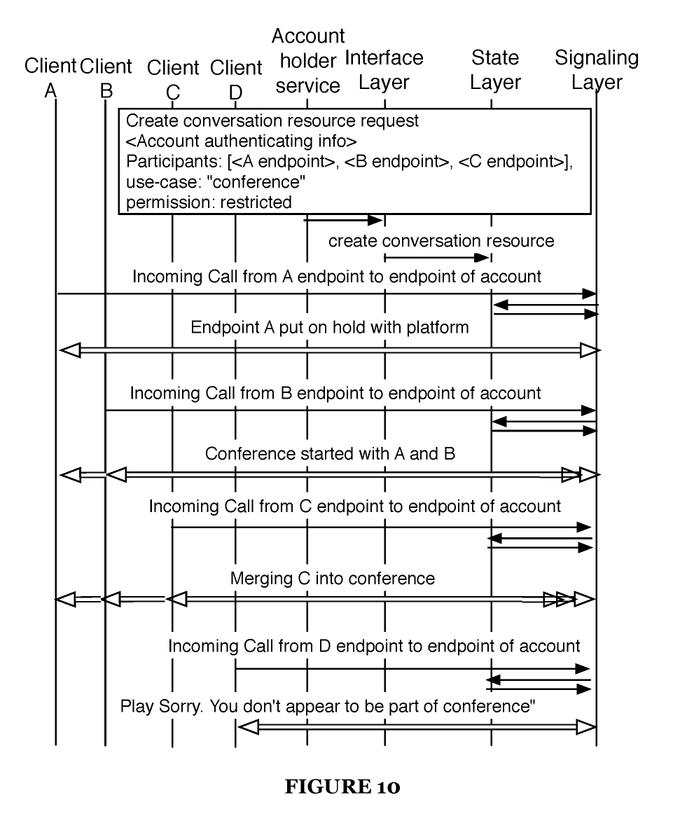

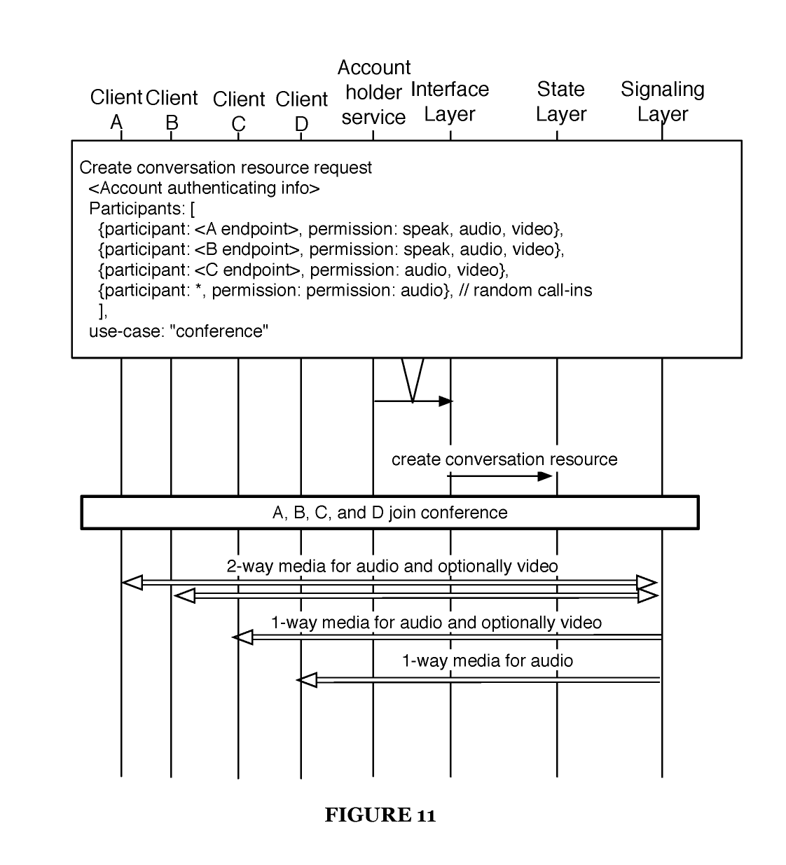

Simplifying conferencing functions to enable configuration driven conferencing. Through a conversation resource one time or multi-use conference rooms can be setup. The conferencing use case can involve setting a set of participants within a conversation resource and enabling a conferencing mode for that conversation resource as shown in FIG. 10. A conferencing mode can automatically manage the initialization of a conference which can include setting participants on hold until the conference begins, making announcements based on state changes, controlling conference features (e.g., muting and whispering) and/or any suitable conference features. Permissions can preferably be set within the conference, which can restrict the media and/or roles of participants. As shown in FIG. 11, granular permissions can be controlled on a per participant basis. Additionally, permissions can be set based on a participant classification. An unspecified participant (e.g., someone who dials in but was not listed as a participant) may be granted limited capabilities.

The system and method of the preferred embodiment and variations thereof can be embodied and/or implemented at least in part as a machine configured to receive a computer-readable medium storing computer-readable instructions. The instructions are preferably executed by computer-executable components preferably integrated with the media intelligence platform. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

As a person skilled in the art will recognize from the previous detailed description and from the figures and claims, modifications and changes can be made to the preferred embodiments of the invention without departing from the scope of this invention defined in the following claims.

What is claimed is:

1. A method comprising:
configuring a conversation resource for an account within a communication platform;
registering a set of endpoints as participants of the conversation resource;
establishing a synchronous media communication session of the conversation resource according to at least the set of endpoints;
maintaining the state of the conversation resource in synchronization with events of the synchronous media communication session; and
servicing at least one programmatic interface to the conversation resource.

2. The method of claim 1, further comprising configuring the account for a set of enabled media capabilities; and wherein establishing a synchronous media communication session comprises establishing the synchronous media communication session in compliance with the enabled media capabilities.

3. The method of claim 1, further comprising configuring the account for media capabilities selected from a set of communication modes comprised of at least a peer-to-peer media mode, an audio mixing media mode, and a video and audio mixing media mode; wherein establishing a synchronous media communication session comprises negotiating a peer-to-peer communication session between the participants if the account is configured for the peer-to-peer media mode; negotiating and facilitating audio mixing for a synchronous audio communication session if the account is configured for the audio mixing media mode; and negotiating and facilitating video and audio mixing for video and audio mixing if the account is configured for the video and audio mixing media mode.

4. The method of claim 1, comprising configuring a conversation resource within the communication platform in a peer-to-peer mode or a media hosted mode; and wherein establishing a synchronous media communication session comprises negotiating a peer-to-peer communication session between participants if the conversation resource is configured in a peer-to-peer mode and negotiating and facilitating a media communication session through the communication platform if the conversation resource is configured in a media hosted mode.

5. The method of claim 4, wherein the mode of a conversation resource is configured based on configuration of a managing account.

6. The method of claim 4, wherein registering the set of endpoints comprises setting endpoint capabilities; and further comprising restricting endpoints as participants according to the endpoint capabilities and the mode of the conversation resource.

7. The method of claim 6, wherein restricting endpoints as participants comprises restricting at least the number of participants and the type of client devices set as endpoints.

8. The method of claim 1, wherein the type of endpoints can include endpoints for PSTN devices, browser clients, and native application endpoints.

9. The method of claim 1, wherein servicing at least one programmatic interface comprises exposing the state of the conversation resource through an HTTP-based application programming interface (API), wherein the state of the conversation can include classification of the conversation as created, in-progress, ended, and failed.

10. The method of claim 1, wherein servicing at least one programmatic interface comprises exposing the conversation resource as a mutable resource, wherein the state of the conversation and state of the participants can be remotely altered through the HTTP-based API.

11. The method of claim 1, wherein registering the set of endpoints as participants of the conversation resource comprises registering a plurality of endpoints for a first participant.

12. The method of claim 1, wherein establishing a synchronous media communication session of the conversation resource according to at least the set of endpoints automatically establishing a first leg of a media communication session between the communication platform and a first participant using an endpoint identifier of the account to connect to an endpoint of the first participant; establishing a second leg of a media communication session between the communication platform and a second participant using the endpoint identifier of the account to connect to an endpoint of the second participant; and bridging the first and second legs of the media communication session at the communication platform.

13. A method comprising:
configuring a conversation resource for an account within a communication platform, wherein the conversation resource is configured with at least a set of participants;
establishing a communication associated with the conversation resource;
maintaining state of the conversation resource in synchronization with at least the state of the communication; and
servicing at least one programmatic interface to the conversation.

14. The method of claim 13, wherein establishing a communication comprises establishing a synchronous communication session between at least a subset of the participants.

15. The method of claim 13, wherein establishing a communication comprises transmitting an asynchronous message between at least a subset of the participants.

16. The method of claim 13, further comprising establishing a plurality of communications associated with the conversation resource, wherein a first established communication is a synchronous communication session and a second established communication is an asynchronous message, wherein maintaining state of the conversation resource is synchronized with the state of the first and second established communications.

17. The method of claim 13, further comprising receiving an inbound communication from one participant and mapping the communication to the conversation resource; and wherein establishing the communication associated with the conversation resource comprises routing the inbound communication to at least one other participant of the conversation resource.

18. The method of claim 13, wherein configuring the conversation resource for an account comprises activating an automatic anonymizing proxy option of the conversation resource wherein establishing the communication comprises automatically establishing a first leg of a communication between the communication platform and a first participant using an endpoint identifier of the account to communicate with the first participant; establishing a second leg of the communication between the communication platform and a second participant using the endpoint identifier of the account to communicate with the second participant.

19. The method of claim 18, wherein the communication is a synchronous communication session; and further comprising bridging the first and second legs of the communication at the communication platform.

20. The method of claim 13, comprising configuring the conversation resource within the communication platform in a peer-to-peer mode or a media hosted mode; and wherein establishing the communication comprises negotiating a peer-to-peer communication session between participants if the conversation resource is configured in a peer-to-peer mode and negotiating and facilitating a media communication session through the communication platform if the conversation resource is configured in a media hosted mode.
